(19) United States
(12) Patent Application Publication
(10) Pub. No.: US 2007/0078057 A1
(43) Pub. Date: Apr. 5, 2007

(54) Microemulsion formulation

(76) Inventors: Keith R. Rowley, Madison, WI (US); Mark Trimmer, Mazomarie, WI (US); Thomas J. Richard, Sunset Hills, MO (US); Clara Leung, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 11/517,004

(22) Filed: Sep. 7, 2006

Related U.S. Application Data
(60) Provisional application No. 60/714,597, filed on Sep. 7, 2005.
(60) Provisional application No. 60/714,598, filed on Sep. 7, 2005.

(51) Int. Cl. A01N 57/18; A01N 25/04; A01N 43/04; A01N 43/40; A01N 25/16; A01N 65/00

(52) U.S. Cl. 504/206; 504/365; 514/28; 514/338; 514/341; 514/65

(57) ABSTRACT

The present invention provides a storage stable microemulsion formulation for modified lecithin as well as other materials. For modified lecithin, the microemulsion contains at least one metal chelate complex, at least one surfactant such as an anionic surfactant, modified lecithin, water, and optionally at least one alcohol. For other materials, the microemulsion contains all above plus one or more other materials wherein modified lecithin can be replaced by unmodified lecithin. Further provided are methods of making and using the above microemulsions.

### CROSS-REFERENCE TO RELATED APPLICATIONS

This application claims the benefit of U.S. Patent Application No. 60/714,597, filed Sep. 7, 2005 and U.S. Patent Application No. 60/714,598, filed Sep. 7, 2005, both of which are herein incorporated by reference as if set forth in their entirety.

### STATEMENT REGARDING FEDERALLY SPONSORED RESEARCH OR DEVELOPMENT

Not applicable.

### BACKGROUND OF THE INVENTION

Emulsions and aqueous solutions are widely used formulations for many actives in a variety of products when the products are desired to be provided in a liquid form. In this regard, emulsions have been used for low water solubility materials. For example, the current commercially available products that contain the low water solubility material modified lecithin for achieving various beneficial effects on plants are provided as emulsions. However, such emulsions typically have a milky, opaque look and limited storage stability at high temperatures. While materials that are sufficiently water soluble may be provided as aqueous solutions that are more stable than emulsions, the aqueous solutions many not spread well on many hydrophobic, biological surfaces to which the materials are delivered (e.g., surface of leaves and skins) due to the formation of droplets through high contact angles, resulting in poor attachment to and penetration of the surfaces by the materials. Therefore, there is a need for improved formulations for chemicals used in a variety of fields including chemicals used in agriculture, home and garden, pharmaceuticals, personal care (e.g., cosmetics, moisturizers, suntan lotions, etc), animal health, and cleaning products.

### SUMMARY OF THE INVENTION

The present invention provides a storage stable microemulsion formulation for modified lecithin as well as other active materials, chemicals, or agents of interest such as those used in various agriculture products (e.g., for crop protection), home and garden products, pharmaceutical products, personal care products, animal health products, and cleaning products. For modified lecithin, the microemulsion contains at least one metal chelate complex, at least one surfactant such as an anionic surfactant, modified lecithin, water, and optionally at least one alcohol. While the presence of modified lecithin makes the microemulsion biologically active for achieving various beneficial effects when applied to plants, the inventors found that modified lecithin is also an integral part of the microemulsion structure that allows another material to be incorporated to form a microemulsion of the other material. As a structural component, modified lecithin can be replaced by unmodified lecithin. The inclusion of alcohol is preferred when the microemulsion of the present invention is used to formulate modified lecithin or certain other materials such as plant-derived oils.

As used herein, a microemulsion refers to a thermodynamically stable homogeneous system containing oil and water with extremely small dispersed droplets, typically of 100 nm or smaller.

In general, the amount of one or more metal chelate complexes in the microemulsion may range from about 0.05% to about 7%, from about 0.5% to about 7%, from about 1% to about 7%, or from about 1% to about 5% by the total weight of the microemulsion. The amount of one or more surfactants in the microemulsion may range from about 1% to about 30%, from about 3% to about 25%, from about 4% to about 25%, from about 5% to about 15%, or from about 8% to about 12% by the total weight of the microemulsion. The amount of unmodified lecithin, modified lecithin, or both may range from about 0.01% to about 40%, from about 1% to about 20%, from about 2% to about 10%, or from about 2% to about 8% by the total weight of the microemulsion. The amount of water such as deionized water may range from about 10% to about 98%, from about 20% to about 90%, from about 20% to about 80%, from about 30% to about 80%, or from about 40% to about 80% by the total weight of the microemulsion. The amount of one or more alcohols in the microemulsion, if included, may range from about 1% to about 50%, from about 2% to about 40%, from about 3% to about 30%, from about 4% to about 20%, or from about 5% to about 10% by the total weight of the microemulsion. The amount of other materials in the microemulsion, if included, may range from about 0.01% to about 60%, from about 0.1% to about 50%, from about 1% to 50%, from 3% to 45%, or from about 5% to about 40% by the total weight of the microemulsion.

The present invention further provides methods of making and using the above microemulsions.

### BRIEF DESCRIPTION OF THE DRAWINGS

Not applicable.

### DETAILED DESCRIPTION OF THE INVENTION

The present invention provides a storage stable microemulsion formulation for modified lecithin as well as other active materials of interest. For modified lecithin, the microemulsion contains at least one metal chelate complex, at least one surfactant such as an anionic surfactant, modified lecithin, water, and optionally at least one alcohol. In this microemulsion, in addition to providing the biological activity, modified lecithin works with the other components to allow the formation of the microemulsion. For other active materials of interest, the above microemulsion of modified lecithin serves as a base microemulsion into which one or more other active materials of interest are incorporated to form a microemulsion of the other materials. In this regard, modified lecithin serves as a structural component needed for the formation of microemulsion and can be replaced by unmodified lecithin. The other active materials of interest include but are not limited to other active materials of agriculture as well as active materials used in non-agriculture products such as pharmaceutical products, personal care products, animal health products, cleaning products, noncrop pest control products, and home and garden products. The formulation disclosed here is especially useful for forming microemulsions with materials that are pH-labile.

The present invention is based on the inventors' discovery that when modified lecithin was added to a system formed with water, a surfactant, an alcohol and a metal chelate complex, a transparent microemulsion (oil-in-water) was produced as a result. The formation of the microemulsion was detected by the inventors using electron microscopy and Dynamic Light Scattering measurements. For example, as described in the examples below, the discrete particles of one particular formulation prepared by the inventors have a mean size of about 40 nanometers with a range of about 15 to about 90 nanometers.

While microemulsions containing an anionic surfactant, an alcohol, and a metal chelate complex were known for example in connection with certain cleaning agents and polymerization mixtures (see e.g., U.S. Pat. No. 6,455,487 and U.S. Patent Application Publication No. 2005/0032976), the metal chelate complex in these prior art microemulsions was not a structural part of the microemulsion but rather served some other purposes such as, as initiators for polymerization reactions. It took the inventors by surprise that a metal chelate complex as a required structural element helped the formation of the microemulsion. In addition, the microemulsion formed spontaneously at ambient temperature (e.g., 15° C. to 45° C. or 20° C. to 30° C.) and pressure and around neutral pH (e.g., 5.5-7.5).

The inventors further found that modified lecithin, a biologically active agent which can make the microemulsion useful for delivering beneficial effects to plants, is also an integral part of the microemulsion structure that allows the incorporation of other materials to form microemulsions of other materials. As a structural component, modified lecithin can be replaced by unmodified lecithin.

In addition to modified lecithin, the present invention is useful for making microemulsions for unmodified lecithin, plant-derived oils, fertilizers, surfactants, adjuvants, spray additives, and other materials or chemicals used in agriculture such as pest control chemicals as well as certain non-crop pest control chemicals and certain chemicals for home and garden uses. Pest control chemicals that can be formulated with the present invention include acaricides, algicides, antifeedants, avicides, bactericides, repellents, chemosterilants, fungicides, herbicide safeners, herbicides, attractants, insecticides, mating disrupters, molluscicides, nematicides, plant activators, plant growth regulators, rodenticides, synergists, and virucides.

Examples of herbicides include but are not limited to a chloroacetanilide, an arsenical, a carbamate, a dinitroaniline, a dithiocarbamate, an imidazolinone, an organophosphate, a phenoxy, a pyridine, a triazine, a quaternary ammonium, a sulfonylurea, a benzoylcyclohexanedione, and a triazolopyrimidine.

Examples of insecticides include but are not limited to an arsenical, a botanical, a carbamate, a dinitrophenol, a nicotinoid, an organophosphate, a pyrethroid, a spinosyn, an insect growth regulator, a pyrazole, an oxadiazine, and an anthranilamide.

Examples of fungicides include but are not limited to an amide, an antibiotic, a strobilurin, a carbamate, a copper, a dithiocarbamate, an imidazole, an organophosphate, a conazole, a dicarboximide, a morpholine, an oxazole, a pyridine, a pyrimidine, a pyrrole, a quinone, a thiazole, and a thiocarbamate.

Examples of plant growth regulators include but are not limited to an auxin, a cytokinin, a defoliant, a gibberellin, a growth inhibitor, a growth retardant, and a growth enhancer.

The present invention is also useful for making microemulsions for pharmaceuticals (e.g., lipophilic drugs), personal care products (e.g., cosmetics such as cosmetic fragrances and oils, cleansing fragrances, moisturizers, suntan lotions, and others), animal health products, and cleaning products. Examples of pharmaceuticals include but are not limited to an anti-infective agent, a cardiovascular agent, a central nervous system drug, an expectorant and cough preparation, a gastrointestinal drug, a hormone, an HMG-COA reductase inhibitor, a proton pump inhibitor, an antidepressant, an antipsychotic, an antiarthritic, a nonsteroidal anti-inflammatory drug, a sexual function disorder agent, and an insomnia agent.

As specific examples, the examples below show that the present invention can be used to prepare microemulsion formulations for modified lecithin, vitamin E (α-tocopheryl acetate), prednisone, hexane, toluene, xylene, thyme oil, lemongrass oil, glyphosate, and Scotts Miracle-Gro™ All Purpose Plant Food (a mixture of macro- and micro-nutrients to facilitate plant growth). Glyphosate is the active ingredient in Monsanto's Roundup™ herbicide. In one embodiment, the microemulsion of the present invention contains one of the above or one of picoxystrobin, kresoxim-methyl, trifloxystrobin, fipronyl, imidacloprid, rynaxapyr, mesotrione, and azoxystrobin.

For many chemicals, materials, and agents, a higher amount can be formulated into the microemulsions of the present invention than into an emulsion or aqueous solution. This is especially true for low water solubility materials such as modified lecithin. As a result, the present invention allows many chemicals, materials, and agents be made in a concentrated form for storage and shipping and the concentrates can be easily and homogeneously diluted by an end user prior to be applied for intended use.

The chemicals, materials, and agents formulated as the microemulsions disclosed here may also have enhanced efficacy (see e.g., example 17 below). Without intending to be limited by theory, the inventors believe that the microemulsions disclosed here allow the active chemicals to stay on and penetrate their targets more effectively.

Another advantage of the present invention is that a cleanser based on the formulation disclosed herein can clean a surface with little or no visible residues left behind.

In one aspect, the present invention relates to a microemulsion for modified lecithin or one or more other active materials as described above. In one embodiment, deionized water is employed to form the microemulsion. The metal chelate complex can be formed by mixing a metal salt and a chelating agent, in stoichiometric amounts, in a solution. Preferred metal salts includes salts of transitional metals and heavy metals (e.g., aluminum, calcium, copper, iron, magnesium, manganese, and zinc).

Agents that can be used to chelate a metal ion are well-known in the art. Examples of such chelating agents include but are not limited to gluconic acid, tartartic acid, citric acid, oxalic acid, lactic acid, ethylenediamine mono-, di- or tri-acetic acid, ethylenediaminetetraacetic acid (EDTA), N-hydroxyethylethylenediamine triacetic acid, nitrilotriacetic acid, diethylene triamine pentaacetic acid, 1-hydroxyethylidene-1,1-diphosphonic acid, amino(tri(methylenephosphonic acid)), ethylenediamine[tetra(methylenephosphonic acid)], 2-phosphonobutane-1,2,4-tricarboxylic acid, and their water soluble salts of these compounds, especially the alkali metal salts and particularly the sodium salts. In an alternative embodiment, EDTA or a salt thereof such as Na₂EDTA or Na₄ EDTA is employed as the chelating agent.

An anionic surfactant is a surfactant that carries a negative charge on the surface active portion of the molecule when it is dissolved or dispersed in water and such surfactants are well known in the art. Examples of anionic surfactants include, but are not limited to carboxylates such as soaps, acyl lactylates, acyl amides of amino acids, esters of sulfuric acid such as alkyl sulfates and ethoxylated alkyl sulfates, sulfonates such as alkyl benzene sulfonates, acyl isethionates, acyl taurates and sulfosuccinates, and phosphates. Other anionic surfactants include, but are not limited to salts of a carboxylic acid and an organic compound with a functional amine group (organic amine compound). The amine group allows the organic compound to form salts with the carboxylic acid. In one embodiment, the use of a sulfonate anionic surfactant is specifically excluded.

As used herein, a carboxylic acid is defined by R—COOH, wherein R is a hydrocarbon chain. Preferably, the hydrocarbon chain has 1 to 24 carbons. The hydrocarbon chain can be saturated, unsaturated, linear, branched, cyclic or polycyclic and can have substituted groups including those with heteroatoms (atoms other than carbon and hydrogen). Examples of heteroatoms include but are not limited to N, S, O and Cl. In some embodiments, the hydrocarbon chain either does not have heteroatoms or only has one or more oxygen heteroatoms. In another embodiment, R is an alkyl, alkenyl, or alkynyl group. In a preferred embodiment, R is an alkyl or alkenyl group. Examples of carboxylic acid that can be used in the present invention include but are not limited to acetic acid, propionic acid, glycolic acid, lactic acid, butyric acid, malic acid, heptanoic acid, octanoic acid, nonanoic acid, decanoic acid, methyldecanoic acid, dodecanoic acid, tridecanoic acid, and tetradecanoic acid.

As used herein, an organic compound with a functional amine group is defined by structure I below: 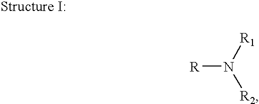
wherein R is a hydrocarbon chain and R₁ and R₂ are either hydrogen or hydrocarbon chains. The hydrocarbon chains of R, R₁, and R₂ can be saturated, unsaturated, linear, branched, cyclic or polycyclic and can have substituted groups including those with heteroatoms (atoms other than carbon and hydrogen). Examples of heteroatoms include but are not limited to N, S, O and Cl. In one form, the hydrocarbon chain either does not have heteroatoms or only has one or more oxygen heteroatoms. In another form, R is an alkyl, alkenyl, or alkynyl group and R₁ and R₂ are hydrogen, alkyl groups, alkenyl roups, or alkynyl groups.

In one embodiment, the organic compound with a functional amine group is an alcohol amine. In one form, R is a hydrocarbon chain containing one or more alcohol moieties and R₁ and R₂ are hydrogen, alkyl groups, or hydrocarbon chains containing one or more alcohol moieties and wherein the hydrocarbon chains have 1 to 6 or 2 to 4 carbons. Examples of the alcohol amines include but are not limited to ethanolamine, HOCH₂CH₂NH₂, HOCH₂CH₂CH₂NH₂, CH₃CH(OH)CH₂NH₂, HOCH₂CH₂N(CH₃)₂, HOCH₂CH₂NHCH₂CH₃, HOCH₂CH₂NHCH₂CH₂OH, HOCH₂CH₂OCH₂CH₂NH₂, HOCH₂CH₂N(CH₂CH₃)₂, HOCH₂CH₂NHCH₂CH₂CH₂CH₃, HOCH₂CH₂N(CH₂CH₂CH₂CH₃)₂. In this embodiment, the corresponding carboxylic acid for forming an anionic surfactant with the organic amine compound has 4 to 24 or 6 to 14 carbon atoms. Examples of such carboxylic acids include but are not limited to heptanoic acid, octanoic acid, nonanoic acid, decanoic acid, methyldecanoic acid, dodecanoic acid, tridecanoic acid, and tetradecanoic acid.

In another embodiment, the organic compound with a functional amine group is an alkyl or alkenyl amine with an alkyl or alkenyl hydrocarbon chain of 8 to 24 or 8 to 18 carbons. In one form, the alkyl or alkenyl amine is defined by R—NH₂ wherein R is an alkyl or alkenyl group. Octylamine is an example of such alkyl amine. In this embodiment, the corresponding carboxylic acid for forming an anionic surfactant with the organic amine compound has 1 to 6 or 1 to 4 carbons. Examples of such carboxylic acids include, but are not limited to acetic acid, propionic acid, glycolic acid, lactic acid, butyric acid, and malic acid.

For the purpose of the present invention, the term alcohol refers to any organic compound with one or more functional groups defined by the following structure:

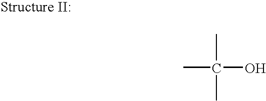

Preferred alcohols are represented by R—OH wherein R is a hydrocarbon chain of 1 to 24 carbons, 1 to 18 carbons, 1 to 12 carbons, 1 to 8 carbons, 1 to 6 carbons, or 1 to 4 carbons The hydrocarbon chain can be saturated, unsaturated, linear, branched, cyclic or polycyclic and can have substituted groups including those with heteroatoms (atoms other than carbon and hydrogen). Examples of heteroatoms include but are not limited to N, S, O and Cl. In one form, the hydrocarbon chain either does not have heteroatoms or only has one or more oxygen heteroatoms. In another form, R is an alkyl, alkenyl, or alkynyl group. In an alternatively embodiment, the alcohol is an alkyl alcohol such as methanol, ethanol, propanol, isopropyl alcohol, butanol, and t-butyl alcohol.

As used herein, the term “modified lecithin” means a lecithin modified to enrich its constituency of plant growth modifying compounds, specifically including enzyme-modified lecithin (EML), chemically modified lecithin (CML), such as acetylated lecithin (ACL) and hydroxylated lecithin (HDL), and other similar modified lecithins such as those having similar plant growth beneficial effects as EML, ACL, and HDL as disclosed in US Patent Application Publication No. 2004/0234657.

Commercially, lecithin or unmodified lecithin refers to a complex product derived from animal or plant tissues that is commonly used as a wetting and emulsifying agent in a variety of commercial products. Lecithin contains acetone-insoluble phospholipids (including phosphatidylcholine (PC), phosphatidylethanolamine (PE), phosphatidylinositol (PI), phosphatidic acid (PA), phosphatidylglycerol (PG), phosphatidylserine (PS) and other phospholipids), sugars, glycolipids, and some other substances such as triglycerides, fatty acids, and cholesterol. Refined grades of lecithin may contain any of these components in varying proportions and combinations depending on the type of fractionation used. In its oil-free form, the preponderance of triglycerides and fatty acids is removed and the product contains 90% or more phosphatides representing all or certain fractions of the total phosphatide complex. The consistency of both natural grades and refined grades of lecithin may vary from plastic to fluid, depending upon free fatty acid and oil content, and upon the presence of absence of other diluents. Its color varies from light yellow to brown, depending on the source and on whether it is bleached or not (usually by hydrogen peroxide and benzoyl peroxide). Lecithin is only partially soluble in water, but it readily hydrates to form emulsions. The oil-free phosphatides are soluble in fatty acids, but are practically insoluble in fixed oils. When all phosphatide fractions are present, lecithin is partially soluble in alcohol and practically insoluble in acetone. Using a food-grade lecithin to make modified lecithin can minimize the safety and environmental concerns over applying modified lecithin to food products. By current definition, a food-grade lecithin (CAS: 8002-43-5) has the following properties: (1) acetone-insoluble matter (phosphatides) is not less than 50%; (2) acid value is not more than 36; (3) heavy metals (as Pb) is not more than 0.002%; (4) hexane-insoluble matter is not more than 0.3%; (5) lead is not more than 10 mg/kg; (6) peroxide value is not more than 100; and (7) water is not more than 1.5%.

EML refers to a lecithin that has been enzymatically modified (e.g., by phospholipase A₂ or pancreatine), a modification done to enhance the surfactant or emulsifying characteristics of the lecithin. Chemical procedures can also be used to make similar modifications as those made by phospholipase A₂. Using a food-grade EML can minimize the safety and environmental concerns. By current definition, a food-grade EML has the following properties: (1) acetone-insoluble matter (phosphatides) is not less than 50%; (2) acid value is not more than 40%; (3) lead is not more than 1 ppm as determined by atomic absorption spectroscopy; (4) heavy metals (as Pb) is not more than 20 ppm; (5) hexane-insoluble matter is not more than 0.3%; (6) peroxide value is not more than 20; (7) water is not more than 4%; and (8) lysolecithin is 50 to 80 mole percent of phosphatides as determined by “Determination of Lysolecithin Content of Enzyme-Modified Lecithin: Method 1 (1985),” incorporated herein by reference as if set forth in its entirety.

Examples of CML include ACL and HDL. These chemical modifications were also intended to enhance the surfactant or emulsifying characteristics of the lecithin. ACL can be prepared by treating lecithin with acetic anhydride. Acetylation mainly modifies phospholipids into N-acetyl phospholipids. HDL can be prepared by treating lecithin with hydrogen peroxide, benzoyl peroxide, lactic acid and sodium hydroxide, or with hydrogen peroxide, acetic acid and sodium hydroxide, to produce a hydroxylated product having an iodine value preferably 10% lower than that of the starting material. Also, the separated fatty acid fraction of the resultant product has an acetyl value of about 30 to about 38.

Lecithin can be obtained from a variety of animal and plant sources including egg yolks, soybeans, sunflowers, peanuts, sesame and canola. The source and process for producing lecithin and methods for enzymatically (e.g., by phospholipase A₂) or chemically modifying lecithin are known to the art. In addition, lecithin, EML, ACL, and HDL are commercially available from a variety of sources such as Solae, LLC (St. Louis, Mo.). Examples of EML and CML that can be used in the present invention can be found in Food Chemicals Codex, 4^{th} ed. 1996, pages 198-221; and 21 C.F.R. sec. 184.1063, sec. 184.1400 and sec. 172.814, each of which are herein incorporated by reference as if set forth in its entirety.

Examples of modified or unmodified lecithin that can be used in the present invention include but are not limited to soy hydroxylated lecithin, soy acetylated lecithin, soy enzyme modified lecithin, and unmodified egg yolk lecithin.

With the metal chelate complexes (including metal salts and chelating agents for making metal chelate complexes), the surfactants (including carboxylic acids and organic compounds with functional amine group(s) for making the anionic surfactants), unmodified and modified lecithin, and the alcohols disclosed above, details on the relative amount of each agent and the specific combinations of agents that are suitable for forming microemulsions of the present invention, to the extent not disclosed here, can be readily determined by a skilled artisan, for example, by using a simple mixing experiment as described in the examples. Similarly, whether a particular material can be formulated according to the present invention, to the extent not disclosed here, can also be readily determined by a skilled artisan. The formation of a microemulsion can be identified if, for example, the end product is clear with no visible particulates or turbidity.

One aspect of the invention relates to a method of making a microemulsion of the present invention by mixing (1) water, (2) a metal chelate complex, (3) an anionic surfactant, (4) unmodified lecithin, modified lecithin, or both, (4) optionally alcohol, and (5) optionally another material such as a crop protection material. Instead of providing a metal chelate complex directly, starting materials for forming a metal chelate complex such as a metal salt and a chelating agent can be used for mixing with other components described above. Similarly, instead of providing an anionic surfactant directly, starting materials for forming an anionic surfactant such as a carboxylic acid and an organic amine compound can be used. In forming a microemulsion of the present invention, unmodified lecithin or modified lecithin is added preferably after the anionic surfactant or starting materials thereof are added and more preferably after all other components of the microemulsion are added and mixed. Also preferably, the metal is chelated before the anionic surfactant or starting materials thereof are added.

In one embodiment, a microemulsion of the present invention is formed by (1) providing a first mixture of water and a metal chelate complex, (2) forming a second mixture by mixing in any order (i) the first mixture and (ii) an anionic surfactant or starting materials thereof, and optionally (iii) an alcohol, and (3) mixing unmodified lecithin, modified lecithin, or both with the second mixture to form a microemulsion of the present invention.

Another aspect relates to a method for providing a beneficial effect to a plant or plant part as set forth in US Patent Application Publication No. 2004/0234657 by treating the plant or plant part with a modified lecithin microemulsion as disclosed herein.

In one embodiment, the method relates to improving the quality of harvested plant parts such as fruits, vegetables, flowers and tubers by treating the plant or plant parts with an effective amount of modified lecithin provided in a microemulsion. In a related embodiment, the method relates to retarding senescence and enhancing the storage and shelf life of the harvested plant parts by treating the plant or plant parts with an effective amount of modified lecithin provided in a microemulsion. For these applications, modified lecithin can be applied to the plant or plant part either before or after they are harvested.

As used herein, the meaning of “quality of a plant part” depends on the plant part in question and refers to at least one of the following: the firmness (turgidity), color, flavor, scent, brix and cracking of the plant part. The quality of the plant part is considered to be improved if the plant part is firmer (more turgid) and/or has a more desirable color, flavor or scent to an average consumer. For fruits, cracking reduction is also considered an improvement in quality.

In another embodiment, the method relates to increasing the size, weight or both of a plant part by treating the living plant or the plant part thereof with an effective amount of modified lecithin provided in a microemulsion. The size of a plant part refers to its volume. A skilled artisan knows how to measure and compare the size of a particular plant part. For example, for a substantially round fruit, diameter can be used as a measure of fruit size. For leaves that have similar thickness, the surface area can be used as an indication of leave size. The modified lecithin microemulsion is particularly useful for increasing the size, weight or both of various fruits, foliage, flowers, bulbs, roots, and tubers.

In a related embodiment, the method relates to enhancing root formation and development of roots on cuttings by treating the plant or cuttings with an effective amount of modified lecithin provided in a microemulsion. By enhancing root formation or development of roots on cuttings, we mean that modified lecithin can increase the number of roots, the overall length of the roots, or both. When a root is a commercial product itself, the method can be used to increase root production. Otherwise, the method can be used to stimulate the growth and development of a plant. In particular, the modified lecithin microemulsion can be added to potting soil media to promote root formation and development.

In another embodiment, the method relates to enhancing tuber formation by treating a tuber plant or the tuber thereof with an effective amount of modified lecithin provided in a microemulsion. By enhancing tuber formation, we mean that modified lecithin can increase the number of tubers.

In another embodiment, the method relates to stimulating turf grass growth by treating the turf grass with an effective amount of modified lecithin provided in a microemulsion. Turf grass growth can be measured by any method familiar to a skilled artisan. For example, dry weight or biomass of the turf grass can be measured.

In another embodiment, the method relates to improving the aesthetic attributes of a plant or plant part by treating the plant or plant part with an effective amount of modified lecithin provided in a microemulsion to improve the overall health of the plant or plant part. This is particularly useful in making the turf grass, bedding plants and other functional and decorative plants more appealing to consumers.

In another embodiment, the method relates to increasing fruit set on or reducing fruit drop from a plant by treating the plant or a suitable part thereof with an effective amount of modified lecithin provided in a microemulsion. Preferably, the whole plant is sprayed with the microemulsion. By increasing fruit set, the number of fruits available for harvest can be increased. By reducing fruit drop, one can reduce fruit loss and potentially increase fruit size as well. The method is particularly useful for fruits such as apples wherein a relatively large number of fruits tend to drop prior to harvest.

In another embodiment, the method relates to protecting a plant, or plant part from a stress related injury. The method involves applying to the plant or plant part an effective amount of modified lecithin provided in a microemulsion. By protecting a plant or plant part from a stress related injury, we mean one or more of the following: (1) complete prevention of the injury; (2) reduction in severity of the injury; (3) recovery from the injury to a higher degree; and (4) speedier recovery from the injury.

As used herein, the term “stress-related injury’ refers to an injury resulting from an abiotic and/or a biotic stress. “Abiotic stress” refers to those non-living substances or environmental factors which can cause one or more injuries to a plant or plant part. Examples of abiotic stress include but are not limited to chilling, freezing, wind, hail, flooding, drought, heat, soil compaction, soil crusting and agricultural chemicals such as pesticides (e.g., insecticides, fungicides, and herbicides) and fertilizers. “Biotic stress” refers to those living substances that cause one or more injuries to a plant or plant part. Examples of biotic stress include but are not limited to pathogens (e.g., fungi, bacteria and viruses), insects, nematodes, snails, mites, weeds and physical damage caused by human and non-human animals (e.g., grazing, and treading). To protect a plant or plant part from stress-related injuries, a modified lecithin microemulsion can be applied at one or more of the following stages: (1) prior to exposure to stress; (2) during exposure to stress; and (3) after exposure to stress. Furthermore, modified lecithin provided in a microemulsion can be used as an adjuvant for pesticides (e.g., plant growth regulators, insecticides, fungicides, and herbicides), fertilizers, and other agrochemicals that people normally use on plants wherein the use can deliver stress to plants.

Yet another aspect relates to a method for eliciting the hypersensitive response in a plant or plant part by treating the plant or plant part with modified lecithin provided in a microemulsion in an amount effective to increase the total activity of an enzyme selected from phenylalanine ammonia lyase, polyphenol oxidase, peroxidase, or acid invertase.

Still another aspect relates to a method for increasing the total activity of an enzyme in a plant or plant part wherein the enzyme is selected from phenylalanine ammonia lyase, polyphenol oxidase, peroxidase, acid invertase, or indole-3-acetic acid oxidase. The method involves treating the plant or plant part with an effective amount of modified lecithin provided in a microemulsion.

Another aspect relates to a method for increasing lignin synthesis in a plant or plant part by treating the plant or plant part an effective amount of modified lecithin provided in a microemulsion.

In practicing the present invention, a skilled artisan can readily determine whether to apply a modified lecithin microemulsion to only one particular plant part or the whole plant. Using stress-related injury protection as an example, if a stress condition only affects one particular plant part and the goal is to protect that particular part, it may be sufficient to treat that particular plant part with modified lecithin.

To treat a plant or plant part with a modified lecithin microemulsion, the plant or plant part can be sprayed with the microemulsion, or it can be dipped or soaked in the microemulsion. Other suitable methods of exposing a plant or plant part to modified lecithin can also be used. For cut-flowers in particular, they can be treated by dipping the cut end of the stem in a modified lecithin microemulsion. For treating underground roots or tubers, a modified lecithin microemulsion can be included in the soil.

The dosage of modified lecithin to be applied for a particular application and the duration of treatment will depend on the type of plant or plant part being treated, the method modified lecithin is being applied, the purpose of the treatment and other factors. A skilled artisan can readily determine the appropriate treatment conditions. Generally speaking, when modified lecithin such as EML is delivered to a target plant or plant part in a microemulsion, its concentration can range from about 1 ppm to about 20,000 ppm, from about 10 ppm to about 10,000 ppm or from about 25 ppm to about 5,000 ppm. The term “about” is used in the specification and claims to cover concentrations that slightly deviate from the recited concentration but retain essential function of the recited concentration.

In another aspect, the present invention relates to a method of killing or inhibiting the growth of a plant by applying a herbicide such as glyphosate provided in a microemulsion of the present invention to the plant in an amount sufficient to kill or inhibit the growth of the plant. Examples of plants include but are not limited to purple ammannia, spurred anoda, barley, barnyardgrass, fivehood bassia, beggarweed, Florida bittercress, annual bluegrass, bulbous bluegrass, downy brome, Japanese brome, browntop panicum, wild buckwheat, burcucumber, buttercup, Carolina geranium, carpetweed, cheat, chervil, chickweed, cocklebur, hophombeam copperleaf, Virginia copperleaf, plains coreopsis, volunteer corn, corn speedwell, crabgrass, crowfootgrass, cutleaf evening primrose, devilsclaw (unicorn plant), dwarf dandelion, Eastern mannagrass, eclipta, Fall panicum, false dandelion, smallseed falseflax, fiddleneck, field pennycress, filaree, annual fleabane, hairy fleabane (Conyza bonariensis), rough fleabane, Florida pusley, giant, bristly, yellow foxtail, Carolina foxtail, green foxtail, jointed goatgrass, goosegrass, grain sorghum (milo), groundcherry, common groundsel, hemp sesbania, henbit, horseweed/marestail (Conyza canadensis), itchgrass, jimsonweed, seedling johnsongrass, junglerice, knotweed, kochia, lambsquarters, little barley, London rocket, mayweed, annual morningglory (Ipomoea spp), blue mustard, tansy mustard, tumble mustard, wild mustard, black nightshade, hairy nightshade, oats, pigweed species, prickly lettuce, purslane, common ragweed, giant ragweed, red rice, volunteer/cereal rye, ryegrass, field sandbur, longspine sandbur, shattercane, shepherd's-purse, sicklepod, broadleaf signalgrass, ladysthumb smartweed, Pennsylvania smartweed, annual sowthistle, spanishneedles, purslane speedwell, sprangletop, prostate spurge, spotted spurge, umbrella spurry, stinkgrass, sunflower, swinecress, teaweed/prickly sida, Texas panicum, Russian thistle, velvetleaf, Virginia pepperweed, waterhemp, wheat, wheat (overwintered), wild oats, wild proso millet, witchgrass, woolly cupgrass, and yellow rocket.

In another aspect, the present invention relates to a method for killing or inhibiting the growth of an insect by exposing the insect to a microemulsion of the present invention that contains an insecticide such as imidacloprid in an amount sufficient to kill or inhibit the growth of the insect.

In another aspect, the present invention relates to a method for killing or inhibiting the growth of fungus by exposing the fungus to a microemulsion of the present invention that contains a fungicide such as azoxystrobin, picoxystrobin, kresoxim-methyl, or trifloxystrobin in an amount sufficient to kill or inhibit the growth of the fungus.

In another aspect, the present invention relates to a method for increasing the amount of an active agent in a commercial product (e.g., an agriculture product or a non-agriculture product) by providing the active agent in a microemulsion disclosed here. For many chemicals, materials, and agents, a higher amount can be formulated into the microemulsions of the present invention than, for example, into an emulsion or aqueous solution. In the case of modified lecithin, for example, a higher amount can be incorporated into the microemulsions of the present invention than into the existing commercially available emulsions for plant applications.

In another aspect, the present invention relates to a method for formulating an active agent (e.g., an active agent for agricultural use or non-agricultural use) for increased efficacy by providing the agent in a microemulsion of the present invention. Such an emulsion can then be used or applied for the intended use of the agent to increase the efficacy of the agent.

The invention will be more fully understood upon consideration of the following non-limiting examples.

### EXAMPLES

### Example 1

### Microemulsion Evaluation Procedure

To evaluate the various microemulsions described below, the following test procedure was defined. Immediately upon preparation, the test formulation was evaluated for clarity and rated according to the following scale.
5=completely clear with no visible particulates or turbidity.
4=mostly clear, but with slight turbidity.
3=mostly clear, but with suspended particles.
2=slightly turbid with suspended particles.

1=very turbid with insoluble precipitate.

A 1% aqueous dilution of a test emulsion is prepared. 100 ml of deionized water was placed in a 100 ml graduated cylinder. A one ml aliquot of the test microemulsion was quickly added to the top of the cylinder and allowed to disperse for five minutes. The clarity of the resulting dilution was evaluated according to the above rating scale.

The original formulation test microemulsion was also allowed to age at ambient temperature for twenty-four hours, and then evaluated for clarity as described above. This test was used to determine the acute physical stability of the microemulsion. A true microemulsion remains clear for an extended period of time, however, other colloidal suspension precipitate or become turbid on setting.

### Example 2

### Microemulsion Formulation

Table 1 shows a microemulsion of the present invention. The microemulsion was prepared by adding and mixing the agents in the order listed (from top to bottom) at room temperature (RT) and ambient pressure. Any metals were chelated prior to the addition of a surfactant. The EML is Precept™ 8160 purchased from Solae, LLC (St. Louis, Mo.).

TABLE 1

| | Microemulsion 1 |
|---|---|
| Component | Weight % |
| H₂O | 71.15 |
| FeCl₃(6H₂O) | 1.0 |
| ZnCl₂ | 0.25 |
| Na₄EDTA | 2.6 |
| Ethanol | 10.0 |
| Decanoic acid | 7.3 |
| Ethanolamine | 2.7 |
| EML | 5.0 |

This microemulsion was tested for chemical and physical stability and found to be chemically and physically stable at 55° C. for extended storage period and could be frozen and thawed at least 10 times with no apparent degradation. The particle size of this microemulsion was also determined through electron microscopy and Dynamic Light Scattering. The mean particle size was found to be about 40 nanometers with a range of about 15 to about 90 nanometers.

Table 2 shows another similarly prepared microemulsion of the present invention.

TABLE 2

| | Microemulsion 2 |
|---|---|
| Component | Weight % |
| H₂O | 71.3 |
| FeCl₃(6H₂O) | 1.0 |
| ZnCl₂ | 0.2 |
| Na₄EDTA | 2.5 |
| Isopropyl alcohol | 10.0 |
| Decanoic acid | 7.4 |
| Ethanolamine | 2.6 |
| EML | 5.0 |

Table 3 shows another microemulsion of the present invention. In particular, the microemulsion was prepared in a 250 ml glass jar containing a magnetic stir bar set to stir at a moderate rate. The ingredients were added in the order listed. The iron and zinc was completely chelated prior to addition of the carboxylic acid and the organic amine compound. The color of the formulation changed from a yellow orange color to a deep amber/red color when all the metals were chelated. The addition of ethanol followed by ethanolamine formed a clear solution that was a slightly deeper amber color. The carboxylic acid readily dissolved into the formulation with a slight amount of heat generation. The solution was stirred for several minutes to insure that all ingredients were completely mixed. EML (Precept™ 8160) was added quickly to the stirring solution. Once the EML was completely wetted, it began to dissolve into the formulation. With moderate stirring, the EML completely dissolved within 5 minutes. A completely clear amber solution was produced.

TABLE 3

| | Microemulsion 3 |
|---|---|
| Component | Weight % |
| H₂O | 71.4 |
| FeCl₃(6H₂O) | 1.0 |
| Na₄EDTA | 2.6 |
| Ethanol | 10.0 |
| Octanoic acid | 7.0 |
| Ethanolamine | 3.0 |
| EML | 5.0 |

The microemulsions in the examples that follow used microemulsion 3 in Table 3 as the starting formulation and were prepared similarly as microemulsion 3. Microemulsion 3 is therefore referred to as the “base” microemulsion in the following examples. When a variable of the microemulsions is changed for evaluation, the amount of water is adjusted accordingly to accommodate the change.

### Example 3

### Effect of Carboxylic Acid Component on “Base” Microemulsions

As shown in Table 3, microemulsions were prepared with carboxylic acids of varying chain lengths.

TABLE 4

| | | Initial | | |
|---|---|---|---|---|
| | | Clarity | 24-Hour Clarity | 1% Dilution |
| Carboxylic Acid | Percent | Rating | Rating | Clarity Rating |
| Butyric (4C) | 4.3 | 1 | 1 | 2 |
| Caproic (6C) | 5.7 | 1 | 1 | 3 |
| Octanoic (8C) | 7.0 | 5 | 5 | 5 |
| Capric (10C) | 8.4 | 5 | 5 | 5 |
| Lauric (12C) | 9.8 | 5 | 5 | 5 |
| Myristic (14C) | 11.2 | 5 | 1 | 5 |
| Oleic (18C) | 13.8 | 1 | 1 | 1 |
| Benzoic | 6.0 | 1 | 1 | 3 |

Carboxylic acids with eight to twelve carbons formed a mixture that possessed the microemulsion characteristics and were stable for at least twenty-four hours. Carboxylic acids with less than eight carbons, however, did not form microemulsions. In these emulsions, the low water solubility chemical (i.e., lecithin) could not be incorporated and therefore remained suspended as a solid. Likewise, carboxylic acids with more than twelve carbons did not form microemulsions.

### Example 4

### Effect of Organic Amine Component on “Base” Microemulsions

As shown in Table 5, microemulsions were prepared with various aminoalcohol/amine components.

TABLE 5

| | | | | 1% |
|---|---|---|---|---|
| | | Initial | 24-Hour | Dilution |
| | | Clarity | Clarity | Clarity |
| Aminoalcohol/Amine | Percent | Rating | Rating | Rating |
| HOCH₂CH₂NH₂ | 3.0 | 5 | 5 | 5 |
| HOCH₂CH₂CH₂NH₂ | 3.7 | 5 | 5 | 5 |
| CH₃CH(OH)CH₂NH₂ | 3.7 | 5 | 5 | 5 |
| OHCH₂CH₂N(CH₃)₂ | 4.4 | 5 | 5 | 5 |
| HOCH₂CH₂NHCH₂CH₃ | 5.0 | 5 | 5 | 5 |
| HOCH₂CH₂NHCOCH₃ | 5.1 | 2 | 2 | 3 |
| HOCH₂CH₂NHCH₂CH₂OH | 5.1 | 5 | 5 | 5 |
| HOCH₂CH₂OCH₂CH₂NH₂ | 5.1 | 5 | 5 | 5 |
| HOCH₂CH₂N(CH₂CH₃)₂ | 5.7 | 5 | 5 | 5 |
| HOCH₂CH₂NHCH₂CH₂CH₂CH₃ | 5.7 | 5 | 5 | 5 |
| HOCH₂CH₂N(CH₂CH₂CH₂CH₃)₃ | 8.5 | 5 | 5 | 5 |
| Methylamine | 1.5 | 1 | 1 | 5 |
| Ethylamine | 2.2 | 1 | 1 | 4 |
| Triethylamine | 4.9 | 4 | 3 | 5 |
| Isoproplyamine | 2.9 | 1 | 1 | 4 |

Table 5 shows that when the alcohol functional group was removed from the amine, a microemulsion did not form.

In microemulsions, the aminoalcohol/amine, such as ethanolamine, and carboxylic acid form an ethanolamine-carboxylic acid salt (EAC). As shown in Table 6, the minimum concentration of EAC was determined. Ethanolamine and octanoic acid were used to be consistent with the “base” microemulsion described above.

TABLE 6

| EAC | Initial Clarity | 24-Hour Clarity | 1% Dilution Clarity |
|---|---|---|---|
| Concentration | Rating | Rating | Rating |
| 0.10% EAC | 1 | 1 | 1 |
| 0.25% EAC | 1 | 1 | 1 |
| 0.5% EAC | 1 | 1 | 1 |
| 0.75% EAC | 1 | 1 | 1 |
| 1.0% EAC | 1 | 1 | 1 |
| 2.0% EAC | 1 | 1 | 1 |
| 3.0% EAC | 2 | 2 | 2 |
| 4.0% EAC | 5 | 5 | 5 |
| 5.0% EAC | 5 | 5 | 5 |
| 10.0% EAC | 5 | 5 | 5 |

Table 6 shows a clear break below which EAC no longer facilitates (i.e. below 4%) the formation of the microemulsion.

### Example 5

### Effect of Metal Salt Component on “Base” Microemulsions

As shown in Table 7, microemulsions were prepared with metal chelates having different metal salts. EDTA was used as the chelation agent for all the metal salts.

TABLE 7

| | | Initial | 24-Hour | |
|---|---|---|---|---|
| | | Clarity | Clarity | 1% Dilution |
| Metal Salt | Percent | Rating | Rating | Clarity |
| FeCl₃(6H₂0) | 1.00 | 5 | 5 | 5 |
| ZnCl₂ | 0.51 | 5 | 4 | 5 |
| CaCl₂(2H₂O) | 0.55 | 5 | 4 | 5 |
| MnCl₂(4H₂O) | 0.75 | 5 | 4 | 5 |
| CuCl₂(2H₂O) | 0.64 | 5 | 5 | 5 |
| Al₂(SO₄)₃ | 1.30 | 4 | 4 | 5 |
| FeSO₄(7H₂O) | 1.10 | 4 | 4 | 5 |
| Fe(CH₃CO₂)₃ | 1.90 | 1 | 1 | 1 |
| Zn(CH₃CO₂)₂(2H₂O) | 0.80 | 5 | 4 | 5 |
| Zn₃(PO₄)₂(4H₂O) | 1.40 | 1 | 1 | 1 |

Table 7 shows that all metal chloride salts tested formed microemulsions.

### Example 6

### Effect of Chelation Component on “Base” Microemulsions

As shown in Table 8, microemulsions were prepared with different chelation agents.

TABLE 8

| | | Initial | | |
|---|---|---|---|---|
| | | Clarity | 24-Hour Clarity | 1% Dilution |
| Chelation Agent | Percent | Rating | Rating | Clarity Rating |
| Citric acid | 1.1 | 5 | 5 | 3 |
| Nitrilotriacetic | 1.1 | 4 | 4 | 5 |
| acid | | | | |
| HEDTA | 1.6 | 5 | 5 | 4 |
| DTPA | 2.3 | 5 | 5 | 3 |
| EDTA | 1.7 | 5 | 5 | 4 |
| Na₂EDTA | 2.2 | 5 | 5 | 5 |
| Na₄EDTA | 2.6 | 5 | 5 | 5 |

Table 8 shows that the EDTA sodium salts were more effective chelating agents for forming the microemulsion. Many of the other chelators were in the form of a free acid, which could be an explanation why they were not as effective in forming microemulsions.

As shown in Table 9, microemulsions were prepared with varying concentrations of metal chelate. Only the metal salt concentration was adjusted —Na₄EDTA was held constant.

TABLE 9

| | | Initial Clarity | 24-Hour Clarity | 1% Dilution |
|---|---|---|---|---|
| Metal Salt | Percent | Rating | Rating | Clarity |
| FeCl₃(6H₂0) | 0.0 | 3 | 3 | 3 |
| FeCl₃(6H₂0) | 0.1 | 3 | 3 | 5 |
| FeCl₃(6H₂0) | 0.25 | 3 | 3 | 5 |
| FeCl₃(6H₂0) | 0.5 | 3 | 3 | 5 |
| FeCl₃(6H₂0) | 0.75 | 4 | 4 | 5 |
| FeCl₃(6H₂0) | 1.0 | 5 | 5 | 5 |

Table 9 shows that the metal chelate at a concentration of at least 0.75% was required for the microemulsion to form.

Two other microeumlsions were prepared. One microemulsion contained a metal salt, but did not contain the chelation component. The other microemulsion contained neither the metal salt nor the chelation component. Microemulsions did not form in either instance.

### Example 7

### Effect of Alcohol Component on “Base” Microemulsions

As shown in Table 10, microemulsions were prepared with different alcohols.

TABLE 10

| | | Initial | | |
|---|---|---|---|---|
| | | Clarity | 24-Hour Clarity | 1% Dilution Clarity |
| Alcohol | Percent | Rating | Rating | Rating |
| Methanol | 10.0 | 5 | 5 | 5 |
| Ethanol | 10.0 | 5 | 5 | 5 |
| Propanol | 10.0 | 5 | 5 | 5 |
| Iso-propyl | 10.0 | 5 | 5 | 5 |
| alcohol | | | | |
| Butanol | 10.0 | 5 | 5 | 5 |
| t-Butyl | 10.0 | 5 | 5 | 5 |
| alcohol | | | | |
| Hexanol | 10.0 | Gel | Gel | 4 |
| Octanol | 10.0 | Gel | Gel | 4 |

Table 10 shows that all short chain alcohols formed stable microemulsions. Interestingly, hexanol and octanol formed gels. The gels had a transparent quality, similar to the microemulsion; however, when dissolved in water, a slightly turbid solution resulted. The gels also did not spontaneously dissolve into water, as they required some mixing to completely dissolve. Microemulsion gels could have utility in the pharmaceutical or personal care products industry.

In addition, and as shown in Table 11, microemulsions with incrementally increased alcohols were prepared.

TABLE 11

| | | Initial Clarity | 24-Hour Clarity | 1% Dilution |
|---|---|---|---|---|
| Alcohol | Percent | Rating | Rating | Clarity Rating |
| Ethanol | 0.0 | 5 | 5 | 5 |
| Ethanol | 0.1 | 5 | 5 | 5 |
| Ethanol | 0.5 | 5 | 5 | 5 |
| Ethanol | 1.0 | 5 | 5 | 5 |
| Ethanol | 5.0 | 5 | 5 | 5 |
| Ethanol | 10.0 | 5 | 5 | 5 |

Table 11 shows that all the microemulsion prepared with the above-identified alcohol concentrations, including the one with 0% ethanol, exhibited microemulsion characteristics. Accordingly, the alcohol concentration can be used to adjust the physical characteristics of the microemulsion and acts as a co-solvent for other added components.

### Example 8

### Effect of Lecithin Component on “Base” Microemulsions

As shown in Table 12, microemulsions were prepared with different modified/unmodified lecithins.

TABLE 12

| | | Initial | 24-Hour | 1% Dilution |
|---|---|---|---|---|
| Modified/Unmodified | | Clarity | Clarity | Clarity |
| Lecithin (Type) | Percent | Rating | Rating | Rating |
| Precept 8120 (soy, | 5.0 | 5 | 5 | 5 |
| hydroxylated) | | | | |
| Precept 8140 (soy, | 5.0 | 5 | 4 | 5 |
| acetylated) | | | | |
| Precept 8160 (soy, | 5.0 | 5 | 5 | 5 |
| enzyme modified) | | | | |
| Centrolex-F (soy, | 5.0 | 5 | 5 | 5 |
| unmodified) | | | | |
| Centrolex-FP40 (soy, | 5.0 | N/A | N/A | N/A |
| high pc content) | | | | |
| Degussa HL-50 (soy, | 5.0 | 4 | 3 | 4 |
| highly enzyme | | | | |
| modified) | | | | |
| Doosan PL-60 | 5.0 | 3 | 3 | 3 |
| (unmodified egg yolk | | | | |
| lecithin, 60% | | | | |
| phospholipids) | | | | |
| Doosan PL-95 | 5.0 | 5 | 5 | 5 |
| (unmodified egg yolk | | | | |
| lecithin, 95% | | | | |
| phospholipids) | | | | |
| Belovo PL-85 | 5.0 | 3 | 3 | 3 |
| (unmodified egg yolk | | | | |
| lecithin, 85% | | | | |
| phospholipids) | | | | |

All of the modified/unmodified lecithins were de-oiled, with much of the protein and triglycerides removed. The soy modified/unmodified lecithins were all free flowing, slightly hygroscopic solids. Conversely, the unmodified egg yolk lecithins were waxy materials and somewhat difficult to handle.

As shown in Table 12, with the exception of the highly enzyme modified lecithin, all of the soy modified/unmodified lecithins produced microemulsions. Highly enzyme modified lecithins are known to contain elevated levels of fatty acids and triglycerides as compared to the other de-oiled soy lecithins evaluated.

The PL-85 and PL-60 unmodified egg yolk lecithins contain significant levels of triglycerides. Conversely, PL-95 is nearly devoid of triglycerides. Table 12 shows that PL-95 unmodified egg yolk lecithin formed a stable microemulsion; whereas the other unmodified egg yolk lecithins did not. As such, it appears that triglycerides cannot be effectively incorporated into the microemulsion.

In addition, and as shown in Table 13, microemulsions with incrementally increased EML were prepared. EML concentrations above 20% required some heat and extended periods of stirring to achieve a clear solution. When heat was required, the emulsion was heated to 45° C. and stirred until a clear solution was achieved. At concentrations above 30%, the EML could not be added in one quick addition. Instead, it needed to be added slowly to prevent caking.

TABLE 13

| | | Initial | 24-Hour | 1% Dilution |
|---|---|---|---|---|
| | | Clarity | Clarity | Clarity |
| EML | Percent | Rating | Rating | Rating |
| Precept 8160 | 5.0 | 5 | 5 | 5 |
| Precept 8160 | 10.0 | 5 | 5 | 5 |
| Precept 8160 | 15.0 | 5 | 5 | 5 |
| Precept 8160 | 20.0 | 5 | 5 | 5 |
| Precept 8160 | 25.0 | 5 | 5 | 5 |
| Precept 8160 | 30.0 | 5 | 5 | 5 |
| Precept 8160 | 40.0 | 5 | 5 | 5 |

Microemulsions containing less than 25% modified lecithin formed spontaneously with only gentle mixing. Microemulsions containing 25% to 40% modified lecithin required some heat (about 45° C. for one 1 hour) along with mixing. As the concentration of modified lecithin increased, so too did the viscosity of the microemulsion. Microemulsions containing 40% modified lecithin were very viscous, but remained free-flowing liquids.

### Example 9

### Microemulsion Formulation with a Long Chain Organic Amine and a Short Chain Carboxylic Acid

Table 14 shows a microemulsion (microemulsion 4) with an anionic surfactant formed with a long chain organic amine compound (octylamine) and a short chain carboxylic acid (glycolic acid). The microemulsion was prepared by adding and mixing the agents in the order listed (from top to bottom) at RT and ambient pressure. The components were added in a 250 ml glass jar containing a magnetic stir bar set to a moderate rate. The EML is Precept™ 8160. The formulation listed in Table 14 resulted in an emulsion that displayed nearly identical physical characteristics to the “base” microemulsion (microemulsion 3) disclosed above.

TABLE 14

| | Microemulsion 4 |
|---|---|
| Component | Weight % |
| H₂O | 71.4 |
| FeCl₃(6H₂O) | 1.0 |
| Na₄EDTA | 2.6 |
| Ethanol | 10.0 |
| Octylamine | 6.3 |
| Glycolic acid | 3.7 |
| EML | 5.0 |

### Example 10

### Effect of Carboxylic Acid Component on Microemulsion 4

As shown in Table 15, carboxylic acids of varying chain lengths were used to replace glycolic acid in microemulsion 4 and all carboxylic acids allowed formation of microemulsion as glycolic acid did.

TABLE 15

| | | Initial | 24-Hour | 1% Dilution |
|---|---|---|---|---|
| | | Clarity | Clarity | Clarity |
| Carboxylic Acid | Percent | Rating | Rating | Rating |
| Glycolic | 3.7 | 5 | 5 | 5 |
| Acetic | 2.9 | 5 | 5 | 5 |
| Proprionic | 3.6 | 5 | 5 | 5 |
| Lactic | 4.4 | 5 | 5 | 5 |
| Butyric | 4.3 | 5 | 5 | 5 |
| Malic | 6.5 | 5 | 5 | 5 |

### Example 11

### Effect of Organic Amine Component on Microemulsion 4

As shown in Table 16, various organic amine compounds with short hydrocarbon chains were used to replace octylamine in microemulsion 4 these organic amine compounds did not allow formation of microemulsions.

TABLE 16

| | | Initial | 24-Hour | 1% Dilution |
|---|---|---|---|---|
| | | Clarity | Clarity | Clarity |
| Organic Amine | Percent | Rating | Rating | Rating |
| Octylamine | 6.3 | 5 | 5 | 5 |
| n-Butylamine | 3.6 | 1 | 1 | 2 |
| sec-Butylamine | 3.6 | 1 | 1 | 2 |
| Hexylamine | 4.9 | 2 | 1 | 2 |
| Cyclohexylamine | 4.8 | 2 | 3 | 2 |
| Benzylamine | 4.2 | 1 | 1 | 2 |
| 6-Aminohexanol | 5.7 | 2 | 2 | 2 |
| Dodecylamine | 9.1 | 5 | 5 | 5 |

### Example 12

### Effect of Metal Salt Component on Microemulsion 4

As shown in Table 17, various metal salts were used to replace FeCl₃(6H₂O) in microemulsion 4 and EDTA was used as the chelation agent. All metal salts used allowed formation of microemulsion.

TABLE 17

| | | Initial | 24-Hour | |
|---|---|---|---|---|
| | | Clarity | Clarity | 1% Dilution |
| Metal Salt | Percent | Rating | Rating | Clarity |
| FeCl₃(6H₂0) | 1.0 | 5 | 5 | 5 |
| ZnCl₂ | 0.51 | 5 | 5 | 5 |
| CaCl₂(2H₂O) | 0.55 | 5 | 5 | 5 |
| CuCl₂(2H₂O) | 0.65 | 5 | 5 | 5 |
| Zn(CH₃CO₂)₂(2H₂O) | 0.85 | 5 | 5 | 5 |

### Example 13

### Effect of Chelation Component on Microemulsion 4

As shown in Table 18, various chelating agents were tested for the formation of microemulsion 4 and EDTA sodium salts were found to be more effective than others.

TABLE 18

| | | Initial | 24-Hour | 1% Dilution |
|---|---|---|---|---|
| | | Clarity | Clarity | Clarity |
| Chelation Agent | Percent | Rating | Rating | Rating |
| Citric acid | 1.1 | 5 | 4 | 3 |
| EDTA | 1.7 | 4 | 5 | 5 |
| Na₂EDTA | 2.2 | 5 | 5 | 5 |
| Na₄EDTA | 2.6 | 5 | 5 | 5 |

### Example 14

### Effect of the Amount of EML on Microemulsion 4

Microemulsion 4 was prepared with different amounts of EML and the results are shown in Table 19.

TABLE 19

| | | Initial | 24-Hour | 1% Dilution |
|---|---|---|---|---|
| | | Clarity | Clarity | Clarity |
| Lecithin | Percent | Rating | Rating | Rating |
| Precept 8160 | 1.0 | 5 | 5 | 5 |
| Precept 8160 | 5.0 | 5 | 5 | 5 |
| Precept 8160 | 10.0 | 5 | 5 | 5 |
| Precept 8160 | 20.0 | 4 | 5 | 2 |
| Precept 8160 | 30.0 | 2 | 5 | 1 |
| Precept 8160 | 40.0 | 1 | — | — |

### Example 15

### Microemulsion Stability

The stability of both microemulsion 3 and microemulsion 4 were subjected to extreme temperature conditions. 15 ml of each microemulsion was placed in a 20 ml glass scintillation vials and stored in a −80° C. freezer for twenty-four hours. When frozen, both microemulsions formed an opaque solid that appeared to be a single phase. No precipitation of solids was observed. Each vial was removed from the freezer and allowed to warm to ambient temperature. Both frozen samples melted quickly to form transparent single phase liquids. There was no evidence of solids precipitation. After both samples has warmed to room temperature, a 1 ml aliquot was removed and added to 100 ml of deionized water. Both produced a clear dilution, as is typical of microemulsions. The freeze thaw cycle was repeated ten times with no apparent impact on the physical characteristics of the microemulsions. Therefore, both microemulsions are physically stable at very low temperatures.

In addition, 50 ml of each microemulsion was placed in a PTFE plastic bottle and stored in a 54° C. oven for three weeks. Stability of a stored sample at 54° C. for 2 weeks approximates 2 years storage stability at ambient temperature as defined in CIPAC (Collaborative International Pesticide Analytical Council) method MT 46.3. Both microemulsion 3 and microemulsion 4 showed no change in color or clarity after being stored at 54° C. for 2 weeks, indicating that no physical degradation had occurred. A 1 ml aliquote of each microemulsion was also added to 100 ml of deionized water and a transparent suspension formed spontaneously, further indicating that the microemulsions were physically stable at elevated temperatures.

Chemical stability of the high-temperature stored microemulsions (54° C.) were determined by analyzing aliquots of each formulation for phospholipid content by HPLC. The phospholipid spectrum was not substantially changed when compared to an original chromatogram. A slight increase in the amount of lysophospholipids was observed with a corresponding decrease in the amount of phospholipids. This is somewhat surprising since conditions were nearly optimum for the hydrolysis of phospholipids to the lyso form. It has been previously observed that lecithin which has been emulsified by high shear mixing and stored at 54° C. rapidly degrades within one week. It is clear that the microemulsion formulation substantially enhances the chemical stability of the phospholipid component.

The high-temperature study was continued for a total of eight months and was terminated when one of the storage containers ruptured at a seam. Periodic physical analysis of the formulations showed that both microemulsions retained their characteristics throughout the entire storage period. The only physical change observed was a very slight darkening of the color.

The effect of pH on the stability of microemulsions 3 and 4 was studied. One hundred ml of aqueous buffer solutions covering a pH range of 1 to 11 were added to graduated cylinders. 1 ml of either microemulsion 3 or microemulsion 4 was added to the cylinder and allowed to disperse. The turbidity of the dilute solutions was determined after five minutes. A clear solution indicated that the microemulsion was stable; whereas, a cloudy solution indicated that the microemulsion collapsed. Tables 20 and 21 show the results on microemulsions 3 and 4, respectively.

TABLE 20

| | 1% Dilution |
|---|---|
| Buffer pH | Clarity Rating |
| 1 | 2 |
| 2 | 3 |
| 3 | 3 |
| 4 | 4 |
| 5 | 5 |
| 6 | 5 |
| 7 | 5 |
| 8 | 5 |
| 9 | 5 |
| 10 | 5 |
| 11 | 5 |

TABLE 21

| | 1% Dilution |
|---|---|
| Buffer pH | Clarity Rating |
| 1 | 5 |
| 2 | 5 |
| 3 | 3 |
| 4 | 2 |
| 5 | 2 |
| 6 | 5 |
| 7 | 4 |
| 8 | 3 |
| 9 | 5 |
| 10 | 4 |
| 11 | 4 |

### Example 16

### Microemulsion Characterization

Both microemulsions 3 and 4 were analyzed for their inherent pH and phospholipid profiles. pH was determined using a calibrated pH meter with a standard combination pH electrode. Microemulsion 3 had a pH of 7.9 and microemulsion 4 had a pH of 6.3.

Phospholipid profiles for each microemulsion was determined by HPLC and compared to that of the modified lecithin used to prepare the formulations (i.e. Precept 8160). Precept 8160 was dissolved in phospholipid HPLC dilution solvent (46% hexane, 46% isopropyl alcohol and 8% water), resulting in a white transparent mixture with no particulates. Both microemulsions 3 and 4 were diluted in the phospholipid HPLC dilution solvent to give slightly turbid mixtures.

Both microemulsions 3 and 4 demonstrated a phospholipid profile nearly identical to that of Precept 8160.

### Example 17

### Microemulsion Formulation for Increasing Fruit Size and Weight

To determine if the microemulsion formulation can be used to deliver active ingredients to plants more effectively, a series of biological trials were conducted. The initial trial involving mixing 50 parts of MT350 (a proprietary product of Nutra-Park, Inc. (Middleton, Wis.) that elicits increased fruit size) with 50 parts of the “base” microemulsion formulation without lecithin. The two components mixed easily to produce an amber transparent solution which possessed the typical microemulsion characteristics. A 0.5% aqueous dilution of this preparation was sprayed on greenhouse grown tomatoes at the appropriate application timing to achieve maximum size increase.

The treatment with the microemulsion formulation increased the fruit size by 143% over the untreated control and by 30% over the treatment with the corresponding non-microemulsion formulation. This was a clear indication that the microemulsion formulation had a positive impact on active ingredient efficacy.

Microemulsion 5 shown in Table 22 (at a rate of 0.5%) and the corresponding non-microemulsion formulation were sprayed on greenhouse tomatoes and compared to an untreated control (UTC). Both treatments increased tomato size over the UTC and the percentage increase over the UTC for both treatments was greater than 50%.

TABLE 22

| | Microemulsion 5 |
|---|---|
| Component | Weight % |
| H₂O | 62.25 |
| FeCl₃(6H₂O) | 1.0 |
| Na₄EDTA | 2.6 |
| Ethanol | 10.0 |
| Ethanolamine | 3.0 |
| Octanoic acid | 7.0 |
| Proprietary ingredients | 9.15 |
| EML | 5.0 |

Microemulsion 5 in Table 22 was applied to a number of multi-acre trials. Table 23 summarizes the results from peach and nectarine trials and Table 24 presents data from recent citrus trials. From the results obtained, inventors determined that the microemulsion formulation both enhance the consistency and efficacy of the active ingredient in comparison to a standard non-microemulsion formulation.

TABLE 23

| | Diameter | | | Weight | | |
|---|---|---|---|---|---|---|
| Trial | UTC | Microemulsion 5 | % Increase | UTC | Microemulsion 5 | % Increase |

Peach

| | | | | | | |
|---|---|---|---|---|---|---|
| 1 | 55.5 | 59 | 6.30 | 90 | 104.9 | 16.60 |

Nectarine

| | | | | | | |
|---|---|---|---|---|---|---|
| 1 | 57.6 | 60.6 | 5.20 | 102.2 | 116.5 | 14.00 |

TABLE 24

| | Diameter | | | Weights | | |
|---|---|---|---|---|---|---|
| Trial | UTC | Microemulsion 5 | % Increase | UTC | Microemulsion 5 | % Increase |

Lemons

| | | | | | | |
|---|---|---|---|---|---|---|
| 1 | 55.1 | 62.6 | 13.6 | 93 | 143 | 53.8 |
| 2 | 54.1 | 65 | 20.1 | 84 | 150 | 78.6 |
| 3 | 55.9 | 68.4 | 22.4 | 101.2 | 178.3 | 76.2 |
| Summary (Avg.) | 55.0 | 65.3 | 18.7 | 92.7 | 157.1 | 69.5 |
| Standard Error | 0.5 | 1.7 | 2.6 | 5.0 | 10.8 | 7.9 |

Oranges, Navel

| | | | | | | |
|---|---|---|---|---|---|---|
| 1 | 70.3 | 90.9 | 29.3 | 169.4 | 345.8 | 104.1 |
| 2 | 71.9 | 83.9 | 16.7 | 172.9 | 270 | 56.2 |
| 3 | 71.4 | 76.7 | 7.4 | 180.5 | 215.5 | 19.4 |
| 4 | 78.2 | 83.2 | 6.4 | 227.6 | 266.6 | 17.1 |
| 5 | 76.5 | 81.1 | 6.0 | 218.2 | 257.5 | 18.0 |
| 6 | 71.9 | 84.3 | 17.2 | 177.3 | 273.2 | 54.1 |
| 7 | 70.3 | 77.5 | 10.2 | 165.5 | 219.6 | 32.7 |
| 8 | 81.9 | 95.5 | 16.6 | 248.4 | 384.4 | 54.8 |
| 9 | 73.3 | 81.5 | 11.2 | 181.9 | 248.3 | 36.5 |
| 10 | 72.7 | 75.7 | 4.1 | 193.5 | 211.9 | 9.5 |
| 11 | 77.4 | 86 | 11.1 | 220.6 | 297.6 | 34.9 |
| 12 | 73.9 | 86.4 | 16.9 | 201.5 | 316.2 | 56.9 |
| 13 | 68.2 | 75.5 | 10.7 | 195.6 | 258.4 | 32.1 |
| 14 | 74.3 | 85 | 14.4 | 210.6 | 308.8 | 46.6 |
| 15 | 75.1 | 84.3 | 12.3 | 215.3 | 295.7 | 37.3 |
| 16 | 72.9 | 84 | 15.2 | 204 | 305.3 | 49.7 |
| Summary (Avg.) | 73.8 | 83.2 | 12.9 | 198.9 | 279.7 | 41.2 |
| Standard Error | 0.9 | 1.3 | 1.5 | 5.9 | 11.8 | 5.7 |

Oranges, Valencia

| | | | | | | |
|---|---|---|---|---|---|---|
| 1 | 62.5 | 66.2 | 5.9 | 121.7 | 152.4 | 25.2 |
| 2 | 66.6 | 80.5 | 20.9 | 153.6 | 227.9 | 48.4 |
| Summary (Avg.) | 64.6 | 73.4 | 13 | 137.7 | 190.2 | 37 |
| Standard Error | 2.1 | 7.2 | 0.1 | 15.9 | 37.8 | 0.1 |

Tangor

| | | | | | | |
|---|---|---|---|---|---|---|
| 1 | 53.3 | 59.5 | 11.6 | 61 | 82 | 34.4 |

Grapefruit/Pomelo

| | | | | | |
|---|---|---|---|---|---|
| 1 | 123.3 | 128.8 | 4.5 | 651.7 | 759.9 |

### Example 19

### Microemulsion Formulation for Impacting Fruit Color

Microemulsion 6 shown in Table 25 was prepared and aqueous dilutions of this formulation at 0.25%, 0.5% and 1.0% were sprayed on greenhouse grown red Medusa hot peppers at an appropriate timing to impact fruit color.

TABLE 25

| | Microemulsion 6 |
|---|---|
| Component | Weight % |
| H₂O | 62.25 |
| FeCl₃(6H₂O) | 1.0 |
| Na₄EDTA | 2.6 |
| Ethanol | 10.0 |
| Ethanolamine | 3.0 |
| Octanoic acid | 7.0 |
| Proprietary ingredients | 9.15 |
| EML | 6.0 |

All treatments with the microemulsion increased the number of red-colored and light red-colored peppers, while decreasing the number of green peppers, when compared to the untreated control.

### Example 20

### Microemulsion Formulation for Herbicides/Pesticides

The incorporation of glyphosate, the active ingredient in Monsanto's Roundup™ herbicide, into the microemulsions of the present invention was evaluated. Glyphosate is an aminophosphonic acid that is soluble in water to about 1%. To improve the water solubility, it is typically formulated as a salt, predominately the isopropylamine or potassium salt. Most commercial formulations contain between 41% and 50% glyphosate salt. The concentration range is driven by the need to maximize the amount of glyphosate in a formulation while maintaining acceptable viscosity.

Microemulsions containing 40.5% of the glyphosate/isopropylamine salt (30% acid) and microemulsions containing 41% to 50% glyphosate/isopropylamine salt were successfully made. Table 26 shows a high glyphosate microemulsion that contains 60.7% glyphosate/isopropylamine salt.

TABLE 26

| | Microemulsion 7 |
|---|---|
| Component | Weight % |
| H₂O | 23.37 |
| Na₄EDTA | 1.33 |
| CuCl₂(2H₂O) | 0.33 |
| Ethanol | 5.0 |
| Isopropylamine | 15.8 |
| Octylamine | 3.2 |
| Acetic acid | 1.5 |
| PEG-300 | 2.0 |
| Glyphosate | 45.00 |
| EML | 2.5 |

Microemulsion 7 was prepared by slurring glyphosate acid into water and then isopropylamine was slowly added with moderate agitation. ETDA was added to the glyphosate/isopropylamine solution and stirred until dissolved. CuCl₂(2H₂O) was added and the copper was immediately chelated by the EDTA. Ethanol, octylamine, PEG-300 and acetic acid were then added with moderate agitation. Finally, the microemulsion was formed by adding Precept 8160 (EML).

Microemulsion 7 formulation possessed several superior characteristics in comparison to the most concentrated commercial glyphosate formulations. Microemulsion 7 was frozen at −80° C. for 24 hours and then thawed at ambient temperature. The microemulsion became fluid within 20 seconds after being removed from −80° C. for 24 hours whereas the commercial formulation remained solid for nearly 5 minutes. The microemulsion also demonstrated little foaming when aggressively agitated.

Similar to glyphosate, other herbicides and pesticides may be formulated with the microemulsion disclosed herein. Many herbicides and pesticides have limited water solubility and significant mounts of organic solvents must be used to effectively formulate them. This resulted in heightened environmental and toxicological concerns. Since the microemulsion formulation of the present invention is aqueous in nature and has very desirable toxicological properties, the environmental and toxicological concerns are lessened. In addition, the microemulsion formulations of the present invention have shown very low viscosities and thus may be used to formulate herbicides and pesticides with favorable viscosity characteristics.

### Example 21

### Microemulsion Formulation for Fertilizers

Table 27 shows a microemulsion prepared with Scotts Miracle-Gro™ All Purpose Plant Food.

TABLE 27

| | Microemulsion 8 |
|---|---|
| Component | Weight % |
| H₂O | 61.4 |
| FeCl₃(6H₂O) | 1.0 |
| Na₄EDTA | 2.6 |
| Ethanol | 10.0 |
| Ethanolamine | 3.0 |
| Octanoic acid | 7.0 |
| Miracle Gro ™ | 10.0 |
| EML | 5.0 |

The effect of the microemulsion formulation of Miracle-Gro™ was evaluated and compared to that of the commercial Miracle-Gro™ formulation. The same amount of fertilizer equivalents of each formulation was added in the recommended manner to two sets of 3 tomato plants. The plants were photographed and the height measured. After 2 days, the microemulsion/Miracle-Gro™ treated plants showed severe damage, consistent with what one might expect if over fertilization had occurred. The Miracle-Gro™ treated plants appeared to be growing normally. One can conclude from this finding that the microemulsion formulation enhanced the plants ability to uptake the nutrients in Miracle-Gro™ to the point of being toxic. It would be expected that one would be able to use significantly less fertilizer to achieve the same result as the commercial Miracle-Gro™ formulation.

Other fertilizers may be similarly formulated with the microemulsions of the present invention. One problem with fertilizer applications is that plants are not able to assimilate the mineral nutrients very efficiently. As a consequence, a significant portion of the applied fertilizer is unutilized. Fertilizers formulated with the microemulsions of the present invention may be utilized more efficiently due to the small fertilizer containing vehicles.

### Example 22

### Microemulsion Formulation for Other Chemicals

Table 28 shows a microemulsion of the present invention that incorporated hexane. In making the microemulsion, hexane was added prior to the addition of EML. After about 5 minutes of stirring, the microemulsion became clear and exhibited typical microemulsion characteristics.

TABLE 28

| | Microemulsion 9 |
|---|---|
| Component | Weight % |
| H₂O | 70.4 |
| FeCl₃(6H₂O) | 1.0 |
| Na₄EDTA | 2.6 |
| Ethanol | 10.0 |
| Ethanolamine | 3.0 |
| Octanoic acid | 7.0 |
| Hexane | 1.0 |
| EML | 5.0 |

The microemulsion formulation for incorporate hexane in Table 28 could also be used to incorporate a higher concentration of hexane as well as a variety of other chemicals (Table 29).

TABLE 29

| | Approximate Maximum |
|---|---|
| Ingredient | Concentration |
| Hexane | 2.0 |
| Toluene | 2.0 |
| Xylene | 5.0 |
| Thyme Oil | 0.5 |
| Lemongrass Oil | 10.0 |
| Vitamin E (α-Tocopherol | 1.0 |
| acetate) | |
| Prednisone | 0.5 |

Although the invention has been described in connection with specific examples, it is understood that the invention is not limited to such specific examples but encompasses all such modifications and variations apparent to a skilled artisan that fall within the scope of the appended claims.

We claim:

1. A microemulsion comprising:
a metal chelate complex;
an anionic surfactant;
a member selected from unmodified lecithin or modified lecithin; and
water.

2. A microemulsion according to claim 1, further comprising an alcohol.

3. A microemulsion according to claim 2, wherein the alcohol is an alkyl alcohol.

4. A microemulsion according to claim 3, wherein the alkyl alcohol has a hydrocarbon chain of 1 to 8 carbons.

5. A microemulsion according to claim 3, wherein the alkyl alcohol has a hydrocarbon chain of 1 to 4 carbons.

6. A microemulsion according to claim 1, wherein the member is modified lecithin.

7. A microemulsion according to claim 1, further comprising a second member selected from a pesticide, a surfactant, an adjuvant, a spray additive, or a fertilizer.

8. A microemulsion according to claim 7, wherein the pesticide is selected from an acaricide, an algicide, an antifeedant, an avicide, a bactericide, a repellent, a chemosterilant, a fungicide, a herbicide safener, a herbicide, an attractant, an insecticide, a mating disrupter, a molluscicide, a nematicide, a plant activator, a plant growth regulator, a rodenticide, a synergist, or a virucide.

9. The microemulsion according to claim 8, wherein the pesticide is a herbicide selected from a chloroacetanilide, an arsenical, a carbamate, a dinitroaniline, a dithiocarbamate, an imidazolinone, an organophosphate, a phenoxy, a pyridine, a triazine, a quaternary ammonium, a sulfonylurea, a benzoylcyclohexanedione, or a triazolopyrimidine.

10. The microemulsion according to claim 8, wherein the pesticide is an insecticide selected from an arsenical, a botanical, a carbamate, a dinitrophenol, a nicotinoid, an organophosphate, a pyrethroid, a spinosyn, an insect growth regulator, a pyrazole, an oxadiazine, or an anthranilamide.

11. The microemulsion according to claim 8, wherein the pesticide is a fungicide selected from an amide, an antibiotic, a strobilurin, a carbamate, a copper, a dithiocarbamate, an imidazole, an organophosphate, a conazole, a dicarboximide, a morpholine, an oxazole, a pyridine, a pyrimidine, a pyrrole, a quinone, a thiazole, or a thiocarbamate.

12. The microemulsion according to claim 8, wherein the pesticide is a plant growth regulator selected from an auxin, a cytokinin, a defoliant, a gibberellin, a growth inhibitor, a growth retardant, or a growth enhancer.

13. A microemulsion according to claim 1, further comprising a second member selected from a pharmaceutically active agent, an active chemical used in a personal care product, an active chemical used in an animal health product, or an active chemical used in a cleaning product.

14. A microemulsion according to claim 13, wherein the second member is a pharmaceutically active agent selected from an anti-infective agent, a cardiovascular agent, a central nervous system drug, an expectorant and cough preparation, a gastrointestinal drug, a hormone, an HMG-COA reductase inhibitor, a proton pump inhibitor, an antidepressant, an antipsychotic, an antiarthritic, a nonsteroidal anti-inflammatory drug, a sexual function disorder agent, or an insomnia agent.

15. A microemulsion according to claim 1, further comprising a member selected from hexane, toluene, xylene, thyme oil, lemongrass oil, α-tocopheryl acetate, prednisone, fipronyl, glyphosate, imidacloprid, rynaxapyr, mesotrione, azoxystrobin, picoxystrobin, kresoxim-methyl, trifloxystrobin, or Scotts Miracle-Gro™ All Purpose Plant Food (a mixture of macro- and micro-nutrients to facilitate plant growth).

16. A microemulsion according to claim 15, wherein the second member is selected from glyphosate, imidacloprid, rynaxapyr, or azoxystrobin.

17. A microemulsion according to claim 1, wherein the metal in the metal chelate complex is a transitional metal or a heavy metal.

18. A microemulsion according to claim 1, wherein the metal chelate complex is formed with a chelating agent selected from EDTA or a salt thereof.

19. A microemulsion according to claim 1, wherein the anionic surfactant is an ionic salt of a carboxylic acid having a hydrocarbon chain of 4 to 24 carbons and an alcohol amine having a hydroxyl group substituted hydrocarbon chain of 1 to 6 carbons.

20. A microemulsion according to claim 19, wherein the carboxylic acid has 6 to 14 carbons on its hydrocarbon chain.

21. A microemulsion according to claim 20, wherein the hydrocarbon chain of the alcohol amine has 2 to 4 carbons.

22. A microemulsion according to claim 1, wherein the anionic surfactant is an ionic salt of a carboxylic acid having a hydrocarbon chain of 1 to 6 carbons and an alkyl or alkenyl amine with a hydrocarbon chain of 8 to 24 carbons for the alkyl or alkenyl group.

23. A microemulsion according to claim 22, wherein the alkyl or alkenyl amine has a hydrocarbon chain of 8 to 18 carbons for the alkyl or alkenyl group.

24. A microemulsion according to claim 22, wherein the carboxylic acid has a hydrocarbon chain of 1 to 4 carbons.

25. A method for preparing a microemulsion comprising the step of:
mixing (a) water,
(b) a first member selected from (i) a metal chelate complex or (ii) starting materials for forming said metal chelate complex that comprise a metal salt and a chelating agent,
(c) a second member selected from (i) an anionic surfactant or (ii) starting materials for forming said anionic surfactant that comprise a carboxylic acid and an organic compound with a functional amine group, and
(d) a third member selected from unmodified lecithin or modified lecithin to form the microemulsion.

26. The method of claim 25, wherein (a), (b), and (c) are mixed first in any order before (d) is added and mixed.

27. A method for preparing a microemulsion comprising the step of:
mixing (a) water,
(b) a first member selected from (i) a metal chelate complex or (ii) starting materials for forming said metal chelate complex that comprise a metal salt and a chelating agent,
(c) a second member selected from (i) an anionic surfactant or (ii) starting materials for forming said anionic surfactant that comprise a carboxylic acid and an organic compound with a functional amine group,
(d) a third member selected from unmodified lecithin or modified lecithin, and
(e) an alcohol to form the microemulsion.

28. The method of claim 27, wherein (a), (b), (c), and (e) are mixed first in any order before (d) is added and mixed.

29. A method for preparing a microemulsion comprising the steps of:
providing a first mixture comprising water and a metal chelate complex;
forming a second mixture by mixing in any order (a) the first mixture and (b) a member selected from (i) an anionic surfactant or (ii) starting materials for forming said anionic surfactant that comprise a carboxylic acid and an organic compound with a functional amine group; and
mixing a member selected from unmodified lecithin or modified lecithin with the second mixture to form the microemulsion.

30. A method for preparing a microemulsion comprising the steps of:
providing a first mixture comprising water and a metal chelate complex;
forming a second mixture by mixing in any order (a) the first mixture, (b) an alcohol, and (c) a member selected from (i) an anionic surfactant or (ii) starting materials for forming said anionic surfactant that comprise a carboxylic acid and an organic compound with a functional amine group; and
mixing a member selected from unmodified lecithin or modified lecithin with the second mixture to form the microemulsion.

31. A method of using modified lecithin to provide a beneficial effect to a plant or plant part comprising the step of applying a microemulsion to the plant or plant part wherein the microemulsion comprises a metal chelate complex, an anionic surfactant, water, and modified lecithin in an amount effective to provide the beneficial effect to the plant or plant part.

32. The method of claim 31, wherein the microemulsion further comprises an alcohol.

33. The method of claim 31, further comprising the step of diluting the microemulsion with water and applying the diluted microemulsion to the plant or plant part.

34. A method of using an agent other than modified lecithin to provide a beneficial effect to a plant or plant part comprising the step of applying a microemulsion to the plant or plant part wherein the microemulsion comprises a metal chelate complex, an anionic surfactant, a member selected from unmodified lecithin or modified lecithin, water, and the agent in an amount effective to provide the beneficial effect to the plant or plant part.

35. The method of claim 34, wherein the microemulsion further comprises an alcohol.

36. A method for killing or inhibiting the growth of a plant comprising the step of applying a microemulsion to the plant wherein the microemulsion comprises a metal chelate complex, an anionic surfactant, a member selected from unmodified lecithin or modified lecithin, water, and a herbicide.

37. The method of claim 35, wherein the microemulsion further comprises an alcohol.

38. The method of claim 35, wherein the herbicide is glyphosate.

39. The method of claim 38, wherein the microemulsion further comprises an alcohol.

40. A method for killing or inhibiting the growth of an insect comprising the step of exposing the insect to a microemulsion that comprises a metal chelate complex, an anionic surfactant, a member selected from unmodified lecithin or modified lecithin, water, and an insecticide.

41. The method of claim 40, wherein the microemulsion further comprises an alcohol.

42. The method of claim 40, wherein the insecticide is selected from imidacloprid or rynaxapyr.

43. The method of claim 42, wherein the microemulsion further comprises an alcohol.

44. A method for killing or inhibiting the growth of a fungus comprising the step of exposing the fungus to a microemulsion that comprises a metal chelate complex, an anionic surfactant, a member selected from unmodified lecithin or modified lecithin, water, and a fungicide.

45. The method of claim 44, wherein the microemulsion further comprises an alcohol.

46. The method of claim 44, wherein the fungicide is selected from azoxystrobin, picoxystrobin, kresoxim-methyl, or trifloxystrobin.

47. The method of claim 46, wherein the microemulsion further comprises an alcohol.

48. A method for increasing the amount of an active agent in a commercial product of interest comprising the step of:
providing in a commercial product a microemulsion that comprises a metal chelate complex, an anionic surfactant, a member selected from unmodified lecithin or modified lecithin, water, and the active agent in an amount more than that of a corresponding existing commercial product.

49. The method of claim 48, wherein the microemulsion further comprises an alcohol.

50. The method of claim 48, wherein the commercial product is an agriculture product.

51. The method of claim 48, wherein the commercial product is a non-agriculture product.

52. A method for formulating an active agent for increased efficacy comprising the step of
forming a microemulsion that comprises a metal chelate complex, an anionic surfactant, a member selected from unmodified lecithin or modified lecithin, water, and the active agent.

53. The method of claim 52, wherein the microemulsion further comprises an alcohol.

54. The method of claim 52, wherein the active agent is for agricultural use.

55. The method of claim 52, wherein the active agent is for non-agricultural use.

56. The method of claim 52, further comprising the step of applying the microemulsion for the intended use of the active agent.
